(19) United States
(12) Patent Application Publication
(10) Pub. No.: US 2014/0149523 A1
(43) Pub. Date: May 29, 2014

(54) METHOD FOR REGULATED INTERACTION BETWEEN VIRTUAL VISIONS IN RESTRICTED VIRTUAL GROUP COMMUNICATIVE LAYERS

(71) Applicant: "DUVAMIS" EOOD, Sofia (BG)

(72) Inventor: Dobromir Hristov GOUSHTEROV, Sofia (BG)

(73) Assignee: "DUVAMIS" EOOD, Sofia (BG)

(21) Appl. No.: 13/897,446

(22) Filed: May 20, 2013

(30) Foreign Application Priority Data
Nov. 27, 2012 (BG) 111353

(51) Int. Cl. H04L 12/58

(52) U.S. Cl. CPC H04L 51/32
USPC 709/206

(57) ABSTRACT

The users (1) via their user devices (2) connect to the network (3) create an own account (5) and their virtual visions (8) whereby the users (1) become creators in the astral media. Via the virtual visions (8) the creators communicate in pre-regulated communicative fragments, called lemmas. One such communicative fragment (lemma) in the astral media is called Legion Lemma (11) whose characteristic feature is that it is regulated as restricted. The Legion Lemma (11) consists of many legions (12). Each of the legions (12) represents a restricted communicative community created by two or more virtual visions (8)—VVi. The legion (12) as the main structural unit of the Legion Lemma (11) entails the formation of such restricted communities of virtual visions VVi based on common interests and the need of usefulness which is why the regulation of the astral media in terms of forming, joining and disbanding legions is purposefully made more complicated. This invention refers to issues related to the creation of one legion (12), adopting new members, leaving a legion, expelling members, and disbanding a legion (12).

### CROSS-REFERENCE TO RELATED APPLICATIONS

This application claims priority to, and the benefit of, under 35 U.S.C. 119, Bulgarian Patent Application No. 111353, filed on Nov. 27, 2012, the disclosure of which is incorporated herein in its entirety.

### TECHNICAL FIELD

The invention refers to a method of regulated interaction between virtual visions in restricted virtual group communicative layers being part of systems for multilayered communicative fragmentation and positioned in a network environment (e.g. Internet) such as social networks, astral media, etc.

The astral media conveys the meaning of the Latin word “medium” as a mediated communicative space in which every user is provided mediated communicative access to other users ensuring a regulated option of maintaining complete social and biological anonymity. In the astral media each user communicates with the other users not based on his/her social features, but using the unlimited number of virtual visions created by him/her which represent projections of his/her mind and thought.

### BACKGROUND OF THE INVENTION

There are known social networks wherein the users connect to the computer network, such as Internet, via user devices in order to be able to use services allowing communication among a large number of users by logging on the respective home page. In order to achieve the above, the users register an own account in the services of the provider and receive access to those services where they can form the so called friendships with a number of other users of the system of the service provider, whereby they form a main, arbitrarily called circle of fiends that they can directly interact with.

A disadvantage of the known social networks is that they do not present an opportunity to build a number of communicatively separate virtual group interactions wherein the users can form friends' groups which are not interconnected with the information posted not being accessible to other, unwanted users. The known social networks make it possible for the user to share information via his/her profile with the shared information becoming accessible not only to his/her pre-approved friends in the system, but indirectly to other users who are not in the circle of friends of the user sharing the information, such as friends of friends.

### SUMMARY OF THE INVENTION

A goal of the invention sets out to develop a method for regulated interaction between virtual visions in restricted virtual group communicative layers whereby the creators of the virtual visions communicate in a mediated manner and have the option of separating the information they post by forming and communicating within restricted interest groups called legions.

This is achieved via a method for regulated interaction between virtual visions in restricted virtual group communicative layers whereby their creators enter into regulated interaction with each other in a network environment. In this case the users of the network connect to the computer network, e.g. Internet, via their user devices. Then the users create their own user account and receive access to the services of the provider. The next step of the users is to create one or many virtual visions associated to their user account thus becoming creators, i.e. creating virtual visions they can use for mediated communication with other creators.

According to the invention the creation of a virtual vision is registered in the data base of the service provider. Via their virtual visions the creators communicate in pre-regulated communicative fragments, called lemmas. One such lemma in the astral media is the legion lemma whose characteristic feature is that it is regulated as restricted.

The Legion Lemma as evident represents one of the communicative layers in the astral media and consists of many legions each of which being a restricted communicative community formed by two or more virtual visions.

Each virtual vision of a given creator can be a member of more than one legion, but the information posted in one legion is only accessible to this legion and does not become known to the other legions the respective virtual vision is a member of.

The creation of a legion takes place based on prior communication in the astral media between at least two virtual visions VV1 and VV2 with the creation starting by the virtual visions approving in advance the initiation of a conversation between the two. After the communication between the two is completed, one of the virtual visions sends an invitation to the other one for the creation of a legion. Upon accepting the invitation, the second virtual vision makes a decision as to whether to agree or refuse to create the respective legion. If the decision is negative, the process ends and no legion is created. If the decision is positive, the two communicating virtual visions adopt rules and specify the differentiating and other features of the newly created legion.

Here it should be noted that the preliminary communication for the creation of the legion takes the form of a conversation between the virtual visions at public or legion levels.

The legions can adopt new members, but the inclusion of a new member in an already existing legion is subject to the rules agreed upon in the legion.

The inclusion of a new member in an existing legion starts with an interaction between the virtual visions VV1 and VV2 and initiation of a public conversation or a conversation in the Legion Lemma. Upon consideration by the legion members they make a decision according to the internal rules of the legion as to whether to initiate or not an invitation for the external virtual vision to join the legion. If the decision of the legion members is negative, no proposal for inclusion is initiated, and if the decision is positive—a proposal is initiated for the new virtual vision to join the legion. The invitation to that effect is initiated by one of the legion members and if accepted, the invited virtual vision becomes a member of the legion following which it is presented with the rules and all the characteristics of the legion.

The rules and characteristics of a legion may change in time in compliance with the adopted legion rules. The change may be initiated by any virtual vision VV1 that is a member of the legion. For the purpose virtual vision VV1 sends to the other legion member a proposal form containing the suggested change in the rules and/or features of the legion. This entails a vote on the proposal and according to the vote results the proposal is either accepted or not. If the result is positive, the new changed rules take effect.

A member voluntarily leaving a legion takes place upon virtual vision VV1 filling in a form for leaving the legion, then sending a system message to the legion members declaring his/her desire to leave the legion after which the system automatically discontinues his/her rights of accessing the legion.

The method also allows for expelling a legion member which takes place when a virtual vision VV1 fills in a proposal form for expelling another virtual vision from the legion, e.g. VV2. Thus a vote is initiated among the legion members in compliance with the legion rules, and if the decision to expel is adopted, the system discontinues the legion access rights of the expelled virtual vision.

Disbanding a legion is only possible if only one virtual vision remains as legion member. Such a situation is possible, if one of the two virtual visions that are members of the legion decides to leave or when one virtual vision proposes to expel the other one. In the occurrence of one of the above situations the system sends a message to the virtual vision still in the legion that the legion has been disbanded for the particular reason after which the access to the legion content is stopped.

The advantage of the invention is in the fact that the method allows the creators of the virtual visions to interact and to separate the information they post by forming and communicating in certain restricted interest groups called legions. In this way the creators mediated by their virtual visions can share different types of information in a virtual group which they chose and which is restricted and invisible to other virtual visions with the exception of those which are members and have access rights.

Another difference with the known virtual group formations is the option to jointly determine the features of the so called legion. These characteristics may include, but are not limited to, name of the legion, coat of arms of the legion, as well as any other characteristics and symbols of the legion chosen by the virtual visions, which the visions can use to reinforce their functional and user sense of secrecy and belonging to the legion and as a whole to form a semblance of interest groups, secret societies or non virtual communities, as well as any other type of virtual group formations wherein all participants are obliged to contribute to selecting the differentiating characteristics of the group via different methods such as voting to accept new features, new members, etc.

The main rationale in setting up these virtual group formations called legions in the astral media is to maintain an agreement among the members in determining such general legion events as adoption of new members, changing, adding or removing features, etc. while at the same time protecting the fundamental right of the creators in the astral media to remain anonymous and communicate freely via the mediation of their virtual visions.

### BRIEF DESCRIPTION OF THE DRAWINGS

FIG. 1 shows a block scheme illustrating the access of the users to the services of the provider.

FIG. 2 shows a block scheme illustrating the creation of a virtual vision.

FIG. 3 shows the main scheme of the Legion Lemma.

FIG. 4 shows the process of creating a new legion.

FIG. 5 shows the process of adopting a new member of the legion.

FIG. 6 shows the process of adopting new rules for the interaction between legion members.

FIG. 7 shows the process of a member leaving the legion.

FIG. 8 shows the process of expelling a legion member.

FIG. 9 shows the process of disbanding a legion.

### DETAILED DESCRIPTION OF THE INVENTION

The method for regulated interaction between virtual visions in restricted virtual group communicative layers whereby the vision creators communicate in the astral media involves the following:

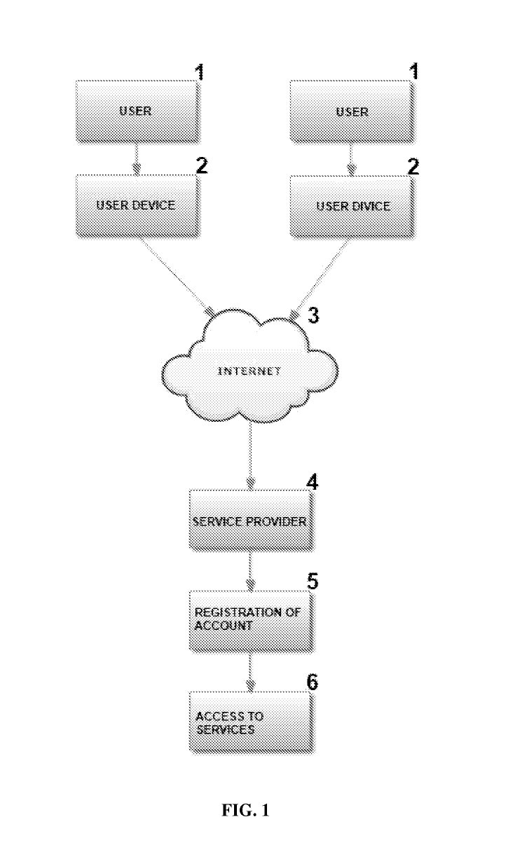

The users 1 via their user devices 2 (tablets, mobile devices, PCs, etc) connect to the network 3 (e.g. Internet)—FIG. 1. After logging in the network 3, the users 1 should create their own account 5 through which to access the services 6 of the provider 4.

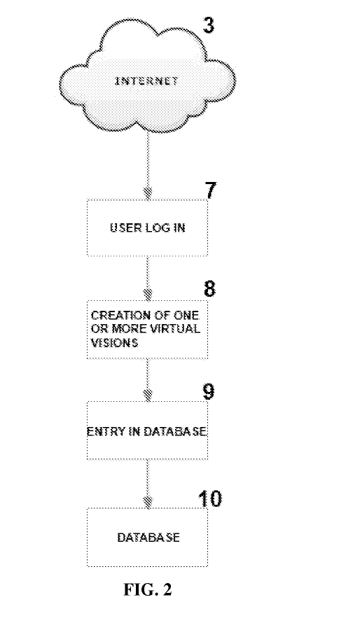

After accessing the services 6 of the provider 4, the users 1 can via their user devices 2 connected to the computer network 3 verify their authorization to use the services of the provider 4. For the purpose they log in 7 the system of the provider using a special form generated by the software of the provider 4. Then they create a virtual vision 8 associated with their user account 5—FIG. 2. Depending on the services of the provider 4 the option to create a virtual vision 8 may be single or multiple. A user of the astral media who has created one or more virtual visions 8 becomes a creator.

The creation of a virtual vision 8 is registered by way of an entry 9 in the data base 10, specially supported by the service provider 4. Using their virtual visions 8 the creators 1 can communicate in pre-regulated computer-network communicative fragments (lemmas). One such communicative fragment in the astral media is the Legion Lemma whose characteristic feature is that it is by rule restricted to its members. In the Legion Lemma of the astral media the information posted in any given legion is only accessible to this legion's members.

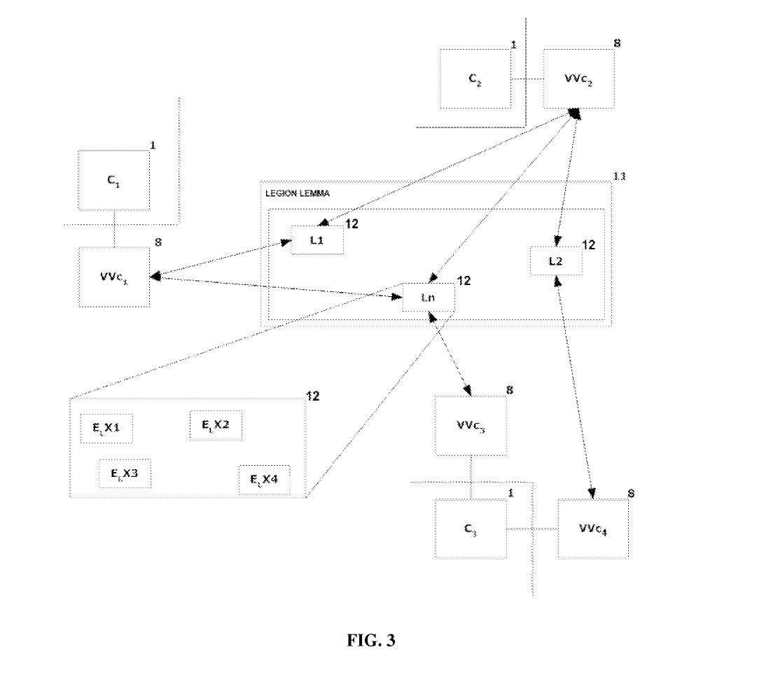

The Legion Lemma 11 represents one of the communicative layers in the astral media 4, realized via specific software. The Legion Lemma 11 consists of a number of legion 12, signified as L1, L2, L3 . . . Ln—FIG. 3. Each of these legions 12 is a restricted communicative community created by two or more virtual visions (VV1, VV2, VV3 and VVn), which interact via special functionalities of the software. It is allowed for each virtual vision VVn of a creator 1 to be a member in more than one legion 12. The membership in different legions can be with the same virtual visions or not. It is to be noted that the information posted in one legion does not become accessible to other legions which the respective virtual vision VVi is a member of, regardless of whether it is concurrently a member in other legions with other virtual visions.

Legion 12 as the main structural unit of the Legion Lemma 11, which is part of the communicative fragmentation regulated in the astral media, entails the formation of such restricted communities of virtual visions VVi based on common interests and the needs of usefulness. This is why the regulation of the astral media in terms of forming, joining and disbanding legions is purposefully made more complicated.

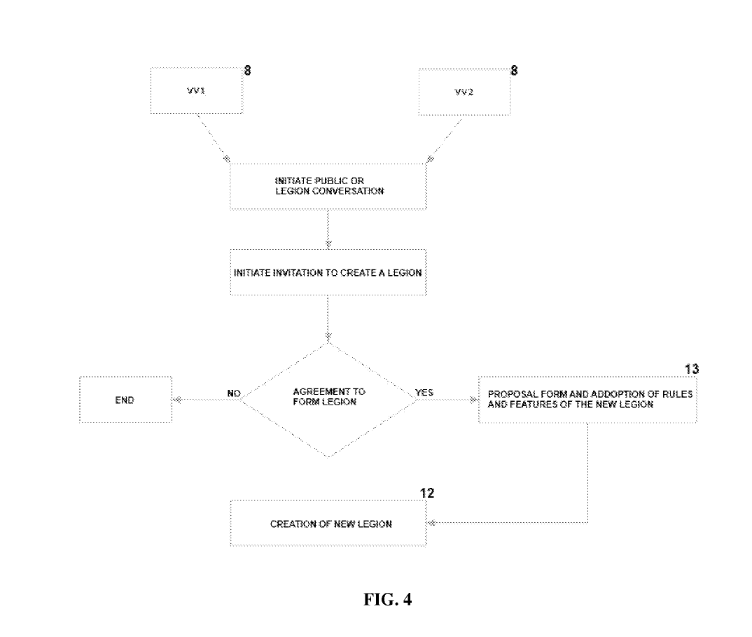

The creation of a legion 12—FIG. 4 unlike in the known social networks takes place based on mandatory initial communication provided as an option by the astral media between the two virtual visions 8 (VV1 and VV2) in a special section of the astral media. This form of communication prior to issuing an invitation to form a legion or an invitation to join an existing legion is mandatory in order to reinforce the feeling of closeness between the virtual visions and their needs of usefulness.

This is also a way to limit the random and not common interest-based interactions, which we perceive as a deficiency of the current social networks.

Creating a legion starts with a prior approval by the virtual visions of the initiation of a public conversation and a conversation in the Legion Lemma 11 between two virtual visions 8—FIG. 4. Once communication is completed and one of the virtual visions 8 decides that a legion can be created with the other virtual vision, the vision sends an invitation-form 13 to create a legion.

The express condition here is that invitations to create and/or join a legion can only be sent following a public or legion conversation. The invitation is accepted by the second virtual vision VV2 and it makes a decision of whether to agree or not to create the particular legion. If the decision is negative, the process ends and no legion is created. If the decision is positive, the two communicating virtual visions VV1 and VV2 adopt rules and specify the differentiating and other characteristics of the newly created legion 12 which completes the process.

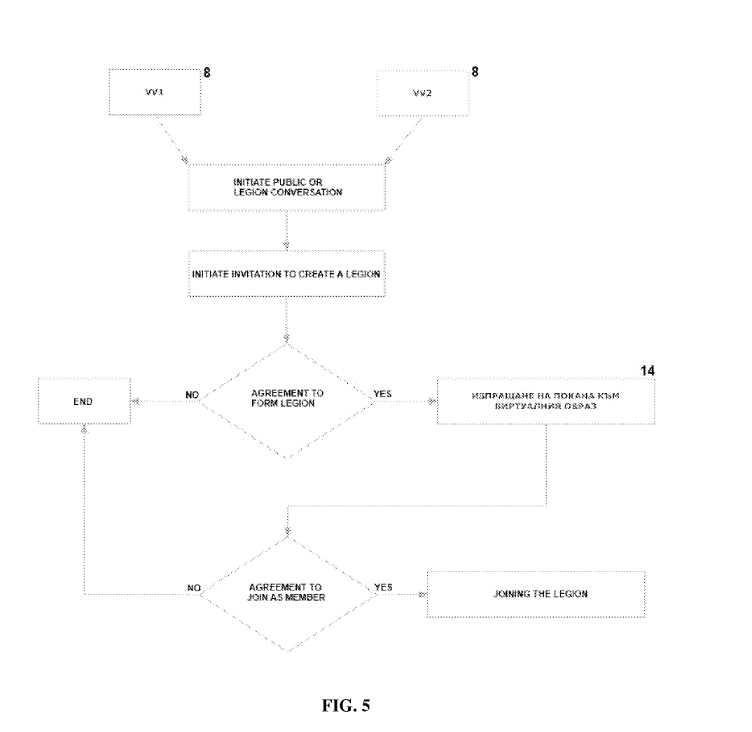

Other virtual visions 8 can join an already created legion. FIG. 5 shows such a process. The adoption of a new member of a legion is conditioned upon the adopted rules of this region. The rules may for instance require a decision to be made by a full, qualified or simple majority, as well as provide for any other requirement as laid down by the service provider 4 to be fulfilled.

The first step is for the virtual visions VV1 and VV2 to establish contact and initiate a public conversation or a conversation in the Legion Lemma. Upon consideration a decision is made by the members of the existing legion in compliance with the legion's internal rules as to whether to invite or not the external virtual vision to join. If the decision of the legion members based on the legion rules is negative, no proposal for inclusion is initiated. If the decision is positive, a proposal is initiated for the new virtual vision to join the legion.

The refusal or the negative decision does not present an obstacle for any of the members of the existing legion to form a new legion with the rejected virtual vision. The process is described above—procedure for creation of a new legion.

If the decision of the legion members in compliance with the rules is positive, a proposal-invitation 14 is initiated for the new virtual vision to join the legion. The invitation 14 is initiated by one of the members VVi of the legion 12. The invitation 14 may be accepted or rejected by the invited virtual vision. If the invitation 14 is accepted, the invited virtual vision joins the legion 12 and becomes a member after which the vision is presented with the rules and all the features of the legion 12.

In this situation the new member has the option of not accepting the rules and the characteristics of the legion. In this case the vision can leave the legion.

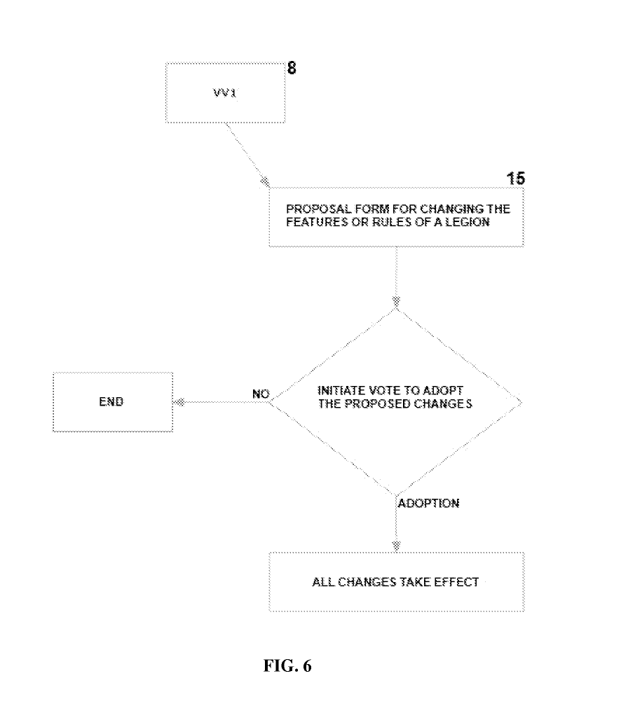

The rules and features of a legion may change in time in compliance with the adopted legion rules. The change in the rules and characteristics of the legion may be initiated by a member virtual vision VV1 at his/her discretion—FIG. 6. For the purpose virtual vision VV1 sends to the other legion members a proposal form 15 containing the suggested change in the rules and/or features of the legion. This entails a vote on the proposal. According to the vote results the proposal is either accepted or not. If the result is positive, the new changed rules take effect.

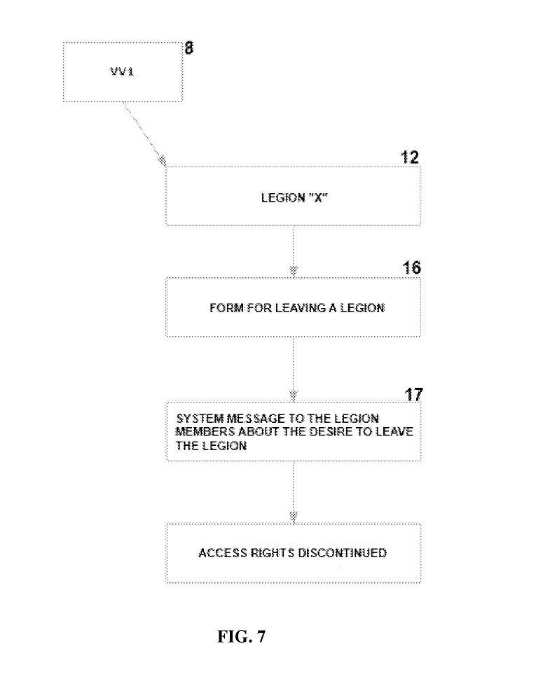

FIG. 7 shows the process of a legion member VV1 leaving a legion. For instance, the virtual vision VV1, member of legion 12, may wish to leave it. For the purpose virtual vision VV1 fills in a form for leaving 16 the legion, and sends a system message 17 to the legion members declaring his/her desire to leave the legion. Then the system automatically discontinues his/her rights of accessing the legion.

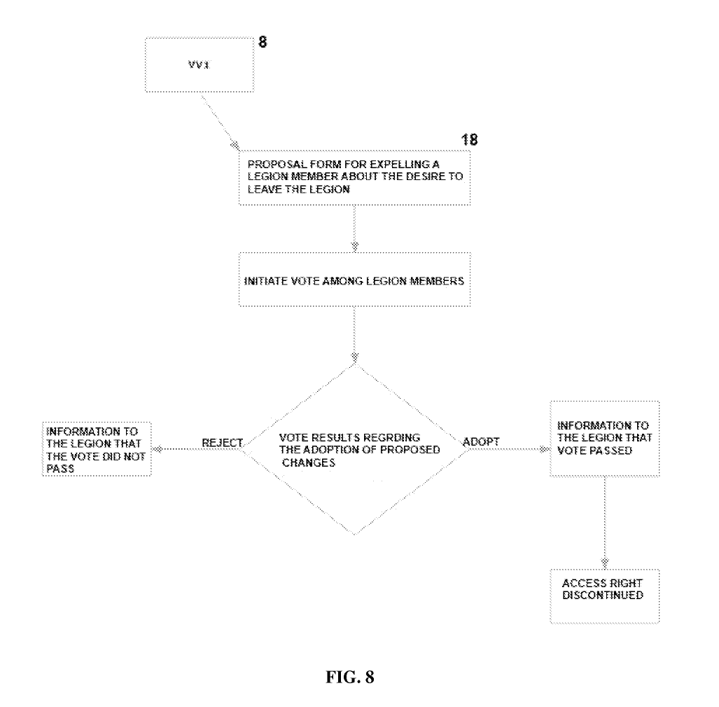

FIG. 8 shows the process of expelling a member from the legion. In this case a legion member, e.g. virtual vision VV1 fills in a proposal form 18 for expelling another virtual vision from the legion, e.g. VV2. Thus a vote is initiated among the members of the legion 12 according to the legion rules. The result of the vote may result in expelling virtual vision VV2 or in rejecting the expulsion. If the decision for expulsion is adopted, the system automatically discontinues the legion access rights of the expelled virtual vision.

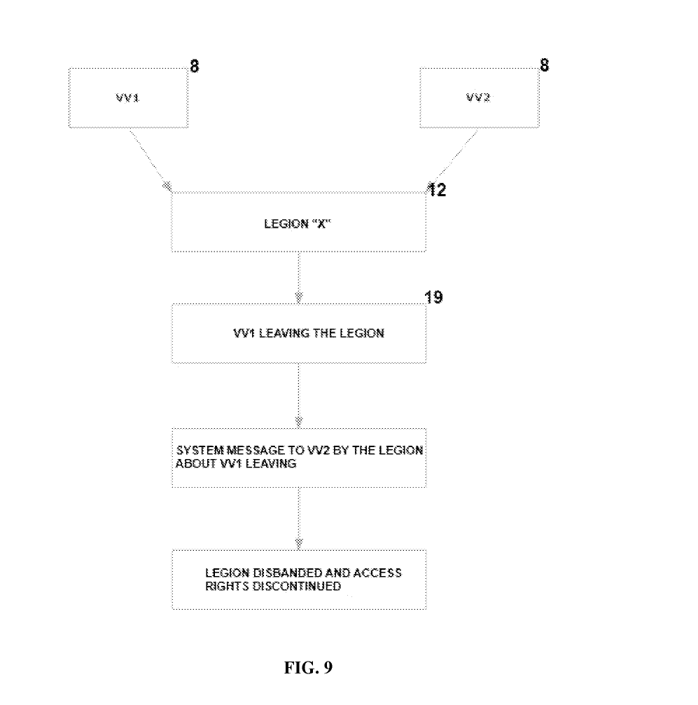

FIG. 9 shows the process of disbanding a legion 12. Disbanding a legion is only possible if only one virtual vision VVi remains as legion member. Such a situation is possible when one of the two virtual visions that are members of the legion decides to leave or when one virtual vision proposes to expel the other one. In the occurrence of one of the above situations the system sends a system message 19 to the virtual vision VVi still in the legion that the legion has been disbanded for the particular reason after which the access to the legion 12 content is stopped.

1. A method of regulated interaction between virtual visions in restricted virtual group communicative layers, wherein the users connect to the computer network via their user devices, create their own user accounts, receive access to the services of the provider, create one or many virtual visions associated with their user account, whereby the users become creators which method is characterized by the fact that the creation of each virtual vision (8) is registered by an entry (9) in a data base (10), provided by the service provider (4) and wherein via their virtual visions (8) the creators communicate in pre-regulated communicative fragments, called lemmas with one such lemma in the astral media being the Legion Lemma (11) whose characteristic feature is that it is regulated as restricted.

2. The method according to claim 1, wherein the Legion Lemma (11) represents one of the communicative levels in the astral media (4) and consists of many legions (12), each of which constitutes a restricted communicative community formed by one of more virtual visions (8).

3. The method according to claim 1, wherein each virtual vision (8) of a given creator (1) can be a member of more than one legion (12).

4. The method according to claim 1, wherein the information posted by a virtual vision (8) in one legion (12) is accessible only to the members of this legion and does not become known to the members of another legion which the respective virtual vision (8) is a member of.

5. The method according to claim 1, wherein the creation of a legion takes place based on prior communication in the astral media between at least two virtual visions (8) (VV1 and VV2) with the creation of a legion (12) starting with the virtual visions (8) approving in advance the initiation of a conversation between the two and after the communication between the two is carried out, one of the virtual visions (8) sends an invitation to the other one for the creation of a legion (12) whereupon by accepting the invitation, the second virtual vision makes a decision as to whether to agree or refuse to create the respective legion (12) and thus if the decision is negative, the process ends and no legion is created and if the decision is positive, the two communicating virtual visions adopt rules and specify the differentiating and other characteristics of the newly created legion (12).

6. The method according to claim 5, wherein the prior communication for the creation of a legion (12) takes the form of a conversation between the virtual visions at public or legion levels.

7. The method according to claim 1, wherein the inclusion of a new member VVi to an existing legion (12) is based on the internal rules of the legion.

8. The method according to claim 1, wherein the inclusion of a new member VVi in an existing legion (12) starts with an interaction between the virtual visions VV1 and VV2 and initiation of a public conversation or a conversation in the Legion Lemma (11) and following consideration by the legion (12) members they make a decision in compliance with the internal rules of the legion as to whether to initiate or not an invitation for the external virtual vision VVi to join the legion and if the decision of the legion members is negative, no proposal for inclusion is initiated, and if the decision is positive, a proposal is initiated for the new virtual vision VVi to join the legion (12) with the invitation (14) to that effect being initiated by one of the legion members and if accepted, the invited virtual vision VVi becomes a member of the legion (12) following which it is presented with the rules and all the features of the legion.

9. The method according to claim 1, wherein the rules and characteristics of a legion may change in time in compliance with the adopted legion rules with the change being initiated by any virtual vision VV1 that is a member of the legion (12) for which purpose virtual vision VV1 sends to the other legion member a proposal form (15) containing the suggested change in the rules and/or characteristics of the legion (12) which entails a vote on the proposal and according to the vote results the proposal is either accepted or not and if the result is positive, the new changed rules take effect.

10. The method according to claim 1, wherein a member VVi voluntarily leaving a legion (12) takes place upon virtual vision VVi filling in a form for leaving the legion after which it sends a system message (19) to the legion (12) members declaring his/her desire to the leave the legion (12) following which the system automatically discontinues his/her rights of accessing the legion.

11. The method according to claim 1, wherein expelling a legion (12) member takes place when a virtual vision VVi fills in a proposal form (18) for expelling another virtual vision from the legion (12), e.g. VV2 which initiates a vote among the legion (12) members in compliance with the legion rules, and if the decision to expel is adopted, the system discontinues the legion (12) access rights of the expelled virtual vision.

12. The method according to claim 1, wherein disbanding a legion (12) is only possible if only one virtual vision Vvi remains as legion member with such a situation being possible if one of the two virtual visions that are members of the legion (12) decides to leave or when one virtual vision proposes to expel the other one and in the occurrence of one of the above situations the system sends a system message (19) to the virtual vision still in the legion (12) that the legion has been disbanded for the particular reason after which the access to the legion content is stopped.
